(19) United States
(12) Patent Application Publication
(10) Pub. No.: US 2025/0109584 A1
(43) Pub. Date: Apr. 3, 2025

(54) EMBEDDED INFILTRATION DEVICE

(71) Applicants: James Llewellyn Lunney Roberts, Haleiwa, HI (US); Gregory Michael Wong, Kailua, HI (US)

(72) Inventors: James Llewellyn Lunney Roberts, Haleiwa, HI (US); Gregory Michael Wong, Kailua, HI (US)

(21) Appl. No.: 18/901,273

(22) Filed: Sep. 30, 2024

Related U.S. Application Data
(60) Provisional application No. 63/587,126, filed on Oct. 1, 2023.

(51) Int. Cl. E03F 1/00; C02F 3/28

(52) U.S. Cl. CPC E03F 1/003; C02F 3/288; C02F 2201/003

(57) ABSTRACT

The present invention recognizes that there exists a long felt need for improved soil infusion wastewater disposal systems for residential and non-residential applications, for sewage and other types of wastewater disposal. A first aspect of the present invention generally relates to devices for above ground soil infusion wastewater disposal, preferably with microorganisms that can assist in the degradation of undesirable materials in such wastewater. A second aspect of the present invention generally relates to methods of making such above ground soil infusion wastewater disposal devices. A third aspect of the present invention generally relates to method of using such above ground soil infusion wastewater disposal devices.

### PRIORITY STATEMENT

The present application:
claims benefit of priority to U.S. Provisional Application Ser. No. 63/587,126, filed Oct. 1, 2023, now pending;
each of which is incorporated by reference in their entirety herein.

### GOVERNMENT SUPPORT

This invention was made with government support under a Small Business Innovation and Research grant awarded by the National Oceanic and Atmospheric Administration (NA23OAR0210563). The government has certain rights in the invention.

### TECHNICAL FIELD

The present invention relates generally to the fields of the disposal of wastewater such as but not limited to sewage by way of infiltration into the soil and preferably evaporation and to a device for the conduction of the procedure, preferably with minimal excavation and grading relative to traditional in ground septic fields. The present invention can be used in residential and non-residential settings.

### BACKGROUND

The conventional standard in leach field design for wastewater disposal has involved the excavation of a series of trenches covering an area sufficient to infiltrate the design volume of treated wastewater into the surrounding soil. The trenches are then filled with about six inches of gravel, ¾″ to 2″ in size, on which a perforated 3″ to 4″ drain pipe is laid. The trenches typically slope at 2″ to 4″/100 ft to facilitate an even gravity distribution of wastewater through the length of the pipe and into the underlying soils. An additional at least 2 inches of gravel is added over the pipe before being covered with geotextile and a layer of at least 9″ of soil. This approach to leach field design has become increasingly replaced over the past 30 years with a gravel-less approach to reduce cost. Gravel-less systems have taken numerous forms over the years, commonly also known as leaching chambers, chambered systems, and septic galleries.

Leaching chambers are bottomless chambers installed in a drainfield excavation with the open bottom of the chamber in direct contact with the excavation. When installed in trenches, molded plastic inverted troughs are commonly used, while when installed in beds concrete “galleries” are often installed directly abutting one another, with partitions that allow the passage of water laterally as well as longitudinally throughout the bed. The chambers also frequently feature sidewall perforations to facilitate the exfiltration of water out of the chamber sides as well as the open bottom. Leaching chambers have been the subject of an excess of patents over the years, though all share the same fundamental inverted trough design; see, for example, the following references.

U.S. Pat. No. 4,759,661 Leaching System Conduit, generally describes a thermoplastic inverted trough with sidewall slot shaped perforations sheltered by lips.

U.S. Pat. No. 3,579,995 Vented Leaching Channel, generally describes a barn or shedlike leaching channel with sheltered sidewall perforations, no bottom, and a vent at the end of each series of units to facilitate air exchange.

U.S. Pat. No. 7,189,027 Corrugated Leaching Chamber, generally describes a molded thermoplastic leaching chamber with a continuous curve arch shape cross section, closely spaced corrugations, and sidewall slots.

U.S. Pat. No. 3,820,341 Leaching Chamber, generally describes an inverted V-shaped leaching chambers with perforated side walls and geometry that facilitates stacking in transport.

U.S. Pat. No. 5,017,041 Leaching System Conduit with High Rigidity Joint, generally describes a corrugated leaching chamber with ends that enable the connection of subsequent chambers.

Also, galleries have been the subject of many patents over the years; see, for example, the following references.

U.S. Pat. No. 4,313,692 Septic Tank Drainage Conduit Structure, generally described a septic tank drainage conduit structures supported on leg members with a completely open bottom area to maximize wastewater absorption downwards.

U.S. Pat. No. 8,636,444 Fluid Distribution System, generally describes a modular or integral appendage for a septic gallery for increased drainage capacity.

U.S. Pat. No. 8,360,100 Integrated Bulk Fluids Management System, generally describes a modular and stackable septic gallery units that feature windows and perforations to control water movement through the system prior to infiltration into the soil.

U.S. Pat. No. 3,339,366 Structure for Leaching Fields, generally describes a generally rectangular shaped individual distribution chambers placed side-to-side and end-to-end on top of the surface of a percolating bed that is then covered by dirt or other fill.

Within gravel-less systems, distribution is typically carried out in one of three ways: 1) gravity distribution via 3″ to 4″ PVC pipes with 0.5″ to 0.75″ holes, 2) dosing pump low-pressure distribution via 1″ to 1.5″ PVC pipes with 5/32″ to ¼″ holes, or 3) simple overland flow within the chamber. Additionally, various patents describe open channel flow type distribution though it is rarely implemented in practice.

The gravel-less wastewater disposal system is a broad category that consists of many slight variations, but all share the common approach of using a subsurface structure, commonly plastic or concrete in the form of an arch or culvert, creating a void space that facilitates the storage and distribution of wastewater underground without the use of gravel. They reduce installation costs by eliminating the use of gravel and often resulting in a significant reduction in the leach field area required by increasing the areal system water storage capacity. However, all such systems still require excavation, a costly practice that requires the use of heavy equipment that's difficult to maneuver on compact residential lots and often leads to soil compaction that reduces the infiltration rate of site soils.

### SUMMARY

The present invention recognizes that there exists a long felt need for improved soil infusion wastewater disposal systems for residential and non-residential applications, for sewage and other types of wastewater disposal.

A first aspect of the present invention generally relates to devices for above ground soil infusion wastewater disposal, preferably with microorganisms that can assist in the degradation of undesirable materials in such wastewater, and preferably with venting to facilitate evaporation.

A second aspect of the present invention generally relates to methods of making such above ground soil infusion wastewater disposal devices.

A third aspect of the present invention generally relates to method of using such above ground soil infusion wastewater disposal devices.

### BRIEF DESCRIPTION OF THE FIGURES

FIG. 1A generally depicts a general view of an above ground soil infusion wastewater disposal system installed with a low pressure distribution line on an uneven grade.

FIG. 1B generally depicts an elevation view of FIG. 1A.

FIG. 2A generally depicts a general view of an above ground soil infusion wastewater disposal system fed with gravity distribution line on an even grade.

FIG. 2B generally depicts an elevation view of FIG. 2A.

FIG. 3A generally depicts a general view of an above ground soil infusion wastewater disposal system that has been trenched to an even grade.

FIG. 3B generally depicts an elevation view of FIG. 3A.

FIG. 4A generally depicts a general view of an above ground soil infusion wastewater disposal system installed with low pressure distribution line in chambers that directly abut one another.

FIG. 4B generally depicts an elevation view of FIG. 4A.

### DETAILED DESCRIPTION OF THE INVENTION

### Definitions

Unless defined otherwise, all technical and scientific terms used herein have the same meaning as commonly understood by one of ordinary skill in the art to which this invention belongs. Generally, the nomenclature used herein and the laboratory procedures in cell culture, chemistry, microbiology, molecular biology, cell science and cell culture described below are well known and commonly employed in the art. Conventional methods are used for these procedures, such as those provided in the art and various general references such as the US EPA Onsite Wastewater Treatment Systems Manual (2002). Where a term is provided in the singular, the inventors also contemplate the plural of that term. The nomenclature used herein and the laboratory procedures described below are those well known and commonly employed in the art. As employed throughout the disclosure, the following terms, unless otherwise indicated, shall be understood to have the following meanings:
“Directly” refers to direct causation of a process that does not require intermediate steps.
“Indirectly” refers to indirect causation that requires intermediate steps.

Other technical terms used herein have their ordinary meaning in the art that they are used, as exemplified by a variety of technical dictionaries.

### Introduction

The present invention recognizes that there exists a long felt need for improved soil infusion wastewater disposal systems for residential and non-residential applications, for sewage and other types of wastewater disposal

As a non-limiting introduction to the breadth of the present invention, the present invention includes several general and useful aspects, including:
1) devices for above ground soil infusion wastewater disposal devices, preferably with microorganisms that can assist in the degradation of undesirable materials in such wastewater, and preferably with venting to facilitate evaporation;
2) methods of making such above ground soil infusion wastewater disposal devices; and
3) methods of using such above ground soil infusion wastewater disposal devices.

These aspects of the invention, as well as others described herein, can be achieved by using the methods, articles of manufacture and compositions of matter described herein. To gain a full appreciation of the scope of the present invention, it will be further recognized that various aspects of the present invention can be combined to make desirable embodiments of the invention.

### I General Aspects of the Present Invention

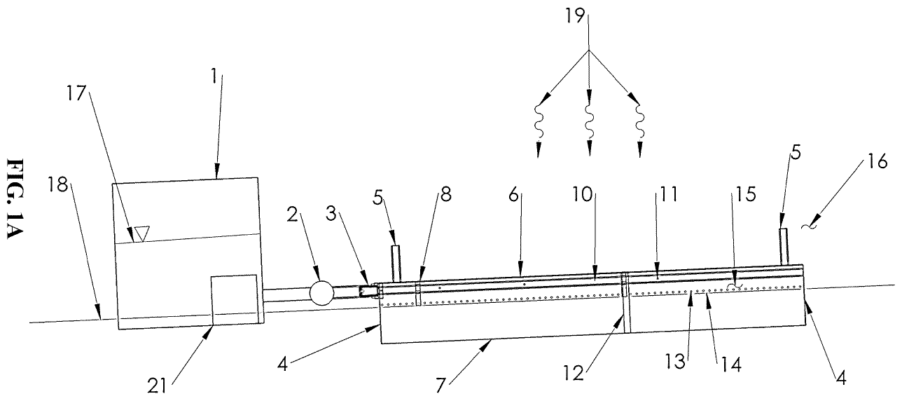

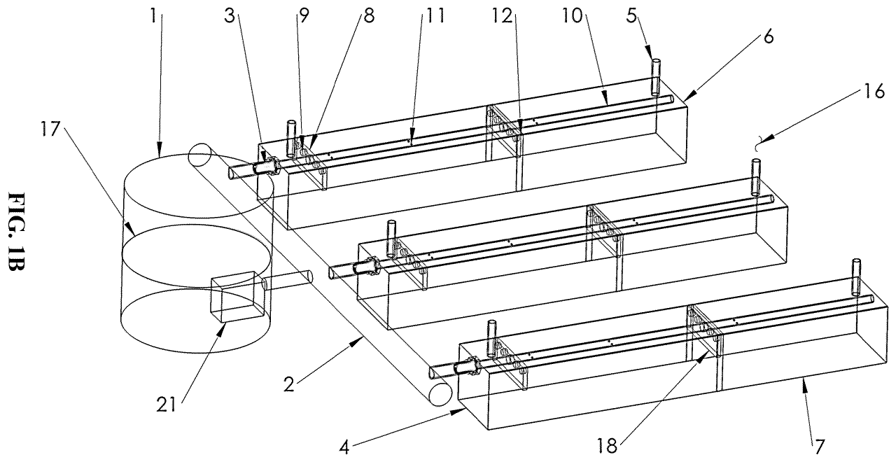

FIG. 1A and FIG. 1B present an illustration of a Residential Aboveground Infiltration Line (RAIL) of the present invention operating with a low-pressure distribution line on an uneven grade. It is noted that the present invention is not limited to residential applications. The equalization chamber (1) collects the water to be disposed of until it meets its threshold water level (17) and the pump (21) or siphon delivers a dose of wastewater to the distribution manifold (2). In low-pressure distribution systems the preferred volume of the dose is typically about 5 to about 10 times the volume of the distribution piping but can be delivered in other doses. The water is distributed from the distribution manifold (2) to a single or multiple parallel RAILs via their inlet structures (3). The end cap (4) and sidewall (7) elements of the RAIL prevent water from surfacing outside of the RAIL by extending from the RAIL to below ground level (18). The sidewalls (7), roof (6), and end caps (4) can be integral to the RAIL or individual components fixed together. The end cap (4) on the upstream end of the RAIL supports the inlet structure (3) that bridges the distribution manifold (2) to the internal pressure pipe (10). The water is distributed through the length of the RAIL via a pressure pipe (10) through perforations (11) at intervals. Bulkheads (8) are installed at intervals sufficient to support the structure as well as minimize overland flow within the RAIL to encourage even infiltration of water even on an uneven grade. Air holes (9) are provided in the bulkheads (8) to allow convective or forced flow of air between the void space (15) and outside environment (16) through the vents (5). A fraction of the water evaporates due to heating of the RAIL by incident radiation (19) and leaves with the convective air flow. The absorbance, reflectivity, and transmissivity of the RAIL sidewalls (7), roof (6), and end caps (4) can be optimized to maximize infiltration and/or evaporation. The remaining fraction infiltrates through the bio-mat (13) at the soil-water interface (14) where microbes entrain and digest suspended solids and consume dissolved organics and nutrients from the water. RAIL lengths can be connected in series to the desired length through joints (12) that connect both the pressure pipe (10) and headspace (15) between segments. Depending on the source, the influent water will commonly require pretreatment to prevent overloading in the form of settling, screening, filtration, biological treatment, chemical treatment, or other wastewater treatment technique.

An example of this is the installation of the RAIL to infiltrate the treated effluent from a septic tank. The septic tank separates out the majority of suspended solids and a fraction of dissolved organics and the clarified effluent can be delivered to the RAIL. Similarly, a gray water source can be subject to an inline mesh screen to remove suspended solids with the filtered effluent being delivered to the RAIL. In onsite residential wastewater treatment and disposal applications, the RAIL can be used to dispose of mixed wastewater streams, grey water streams, or black water streams with varying levels of pretreatment. In addition, wastewater with undesirable components can be treated with the devices and methods of the present invention, in particular in combination with microorganisms that can assist in the degradation of such undesirable components such as but not limited to toxins, heavy metals, pharmaceuticals, and the like.

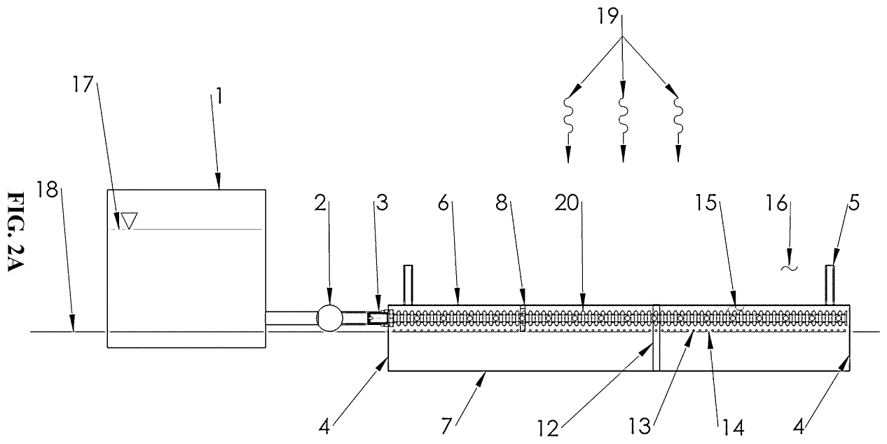

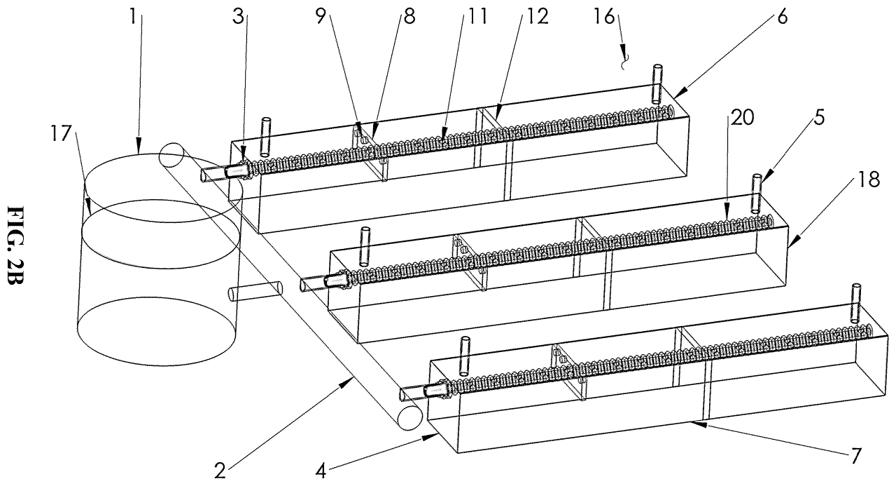

FIG. 2A and FIG. 2B present an illustration of a RAIL fed with gravity distribution line on an even grade. When the water level (17) rises in the equalization chamber (1), the water flows by gravity to the distribution manifold (2) to a single or multiple parallel RAILs via their inlet structures (3). The end cap (4) and sidewall (7) elements of the RAIL prevent water from surfacing outside of the RAIL by extending from the RAIL roof (6) to below ground level (18). The sidewalls (7), roof (6), and end caps (4) can be integral to the RAIL or individual components fixed together. The end cap (4) on the upstream end of the RAIL supports the inlet structure (3) which permits the introduction of water from the distribution manifold (2) to the inside of the RAIL. The water is subsequently distributed through the length of the RAIL via gravity distribution pipe (20) with perforations (11). Bulkheads (8) are installed at intervals sufficient to support the structure. Air holes (9) are provided in the bulkheads (8) to allow convective flow of air between the void space (15) and outside environment (16) through the vents (5). A fraction of the water evaporates due to heating of the RAIL by incident radiation (19) and leaves with the convective air flow. The absorbance, reflectivity, and transmissivity of the RAIL sidewalls (7), roof (6), and end caps (4) can be optimized to maximize infiltration and/or evaporation. The remaining fraction infiltrates through the bio-mat (13) at the soil-water interface (14) where microbes entrain and digest suspended solids and consume dissolved organics and nutrients from the water. RAIL lengths connected in series to the desired length through joints (12) that connect both the gravity distribution line (20) and headspace (15) between segments. Depending on the source, the influent water will commonly require pretreatment to prevent overloading in the form of settling, screening, filtration, biological treatment, chemical treatment, or other wastewater treatment technique.

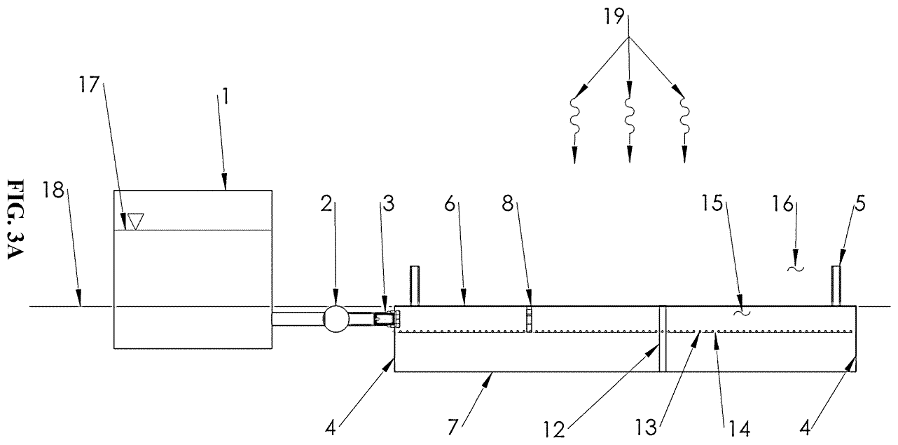

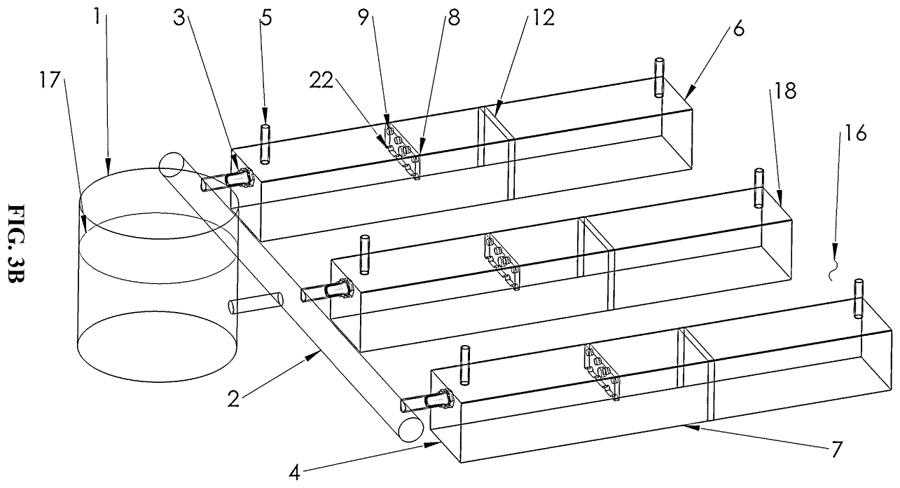

FIG. 3A and FIG. 3B present an illustration of a RAIL for which the underlying ground has been trenched to an even grade and water distributes without an internal pressure pipe or gravity distribution line. When the water level (17) rises in the equalization chamber (1), the water flows by gravity to the distribution manifold (2) to a single or multiple parallel RAILs via their inlet structures (3). The ground level (18) beneath the RAIL has been trenched such that the void space (15) is at least partially below ground level (18). The end cap (4) and sidewall (7) elements of the RAIL prevent water from surfacing outside of the RAIL by extending from the RAIL roof (6) to below ground level (18). The sidewalls (7), roof (6), and end caps (4) can be integral to the RAIL or individual components fixed together. The end cap (4) on the upstream end of the RAIL supports the inlet structure (3) which permits the introduction of water from the distribution manifold (2) to the inside of the RAIL. The water is subsequently distributed through the length of the RAIL via overland flow. Bulkheads (8) are installed at intervals sufficient to support the structure and feature water holes (22) that permit the passage of overland flow of water through the length of the RAIL. Air holes (9) are provided in the bulkheads (8) to allow convective flow of air between the void space (15) and outside environment (16) through the vents (5). A fraction of the water evaporates due to heating of the RAIL by incident radiation (19) and leaves with the convective air flow. The absorbance, reflectivity, and transmissivity of the RAIL roof (6) can be optimized to maximize infiltration and/or evaporation. The remaining fraction infiltrates through the bio-mat (13) at the soil-water interface (14) where microbes entrain and digest suspended solids and consume dissolved organics and nutrients from the water. RAIL lengths connected in series to the desired length through joints (12) that connect both the overland flow and headspace (15) between segments. Depending on the source, the influent water can commonly require pretreatment to prevent overloading in the form of settling, screening, filtration, biological treatment, chemical treatment, or other wastewater treatment technique.

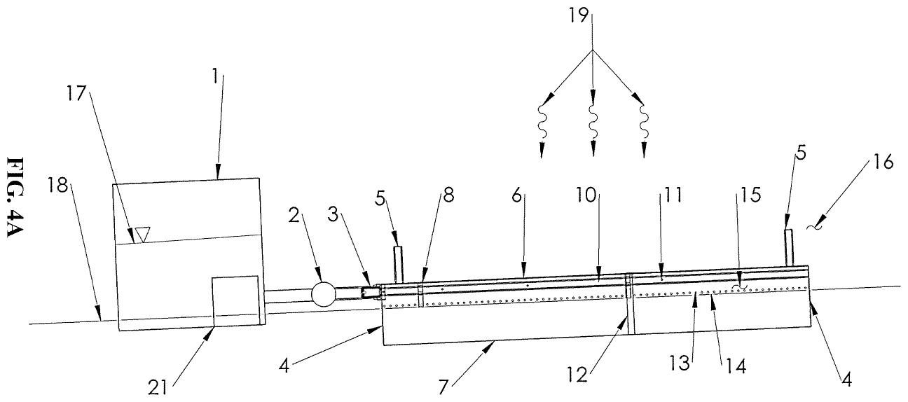

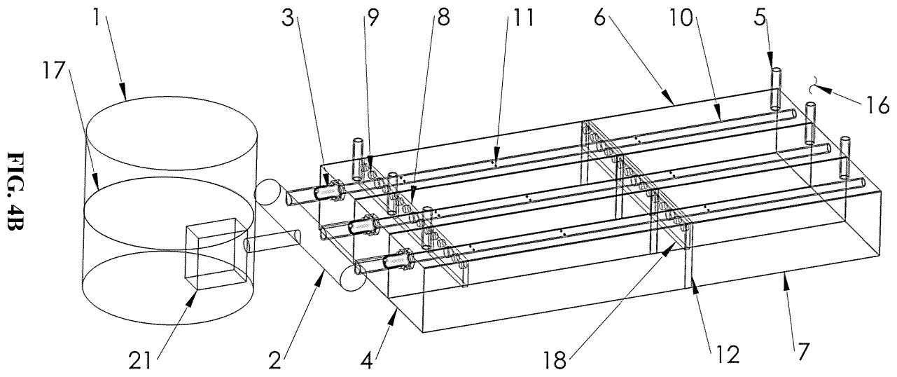

FIG. 4A and FIG. 4B present an illustration of a set of Residential Aboveground Infiltration Lines (RAILs) of the present invention operating with a low-pressure distribution line and directly abutting one another. The equalization chamber (1) collects the water to be disposed of until it meets its threshold water level (17) and the pump (21) or siphon delivers a dose of wastewater to the distribution manifold (2). In low-pressure distribution systems the preferred volume of the dose is typically about 5 to about 10 times the volume of the distribution piping but can be delivered in other doses. The water is distributed from the distribution manifold (2) to multiple RAILs in parallel or in series via their inlet structures (3). The RAILs directly abut one another in a configuration that may be easily concealed beneath a deck or other surface element. The end cap (4) and sidewall (7) elements of the RAIL prevent water from surfacing outside of the RAIL by extending from the RAIL to below ground level (18). The sidewalls (7), roof (6), and end caps (4) can be integral to the RAIL or individual components fixed together. The end cap (4) on the upstream end of the RAIL supports the inlet structure (3) that bridges the distribution manifold (2) to the internal pressure pipe (10). The water is distributed through the length of the RAIL via a pressure pipe (10) through perforations (11) at intervals. Bulkheads (8) are installed at intervals sufficient to support the structure as well as minimize overland flow within the RAIL to encourage even infiltration even on an uneven grade. Air holes (9) are provided in the bulkheads (8) to allow convective or forced flow of air between the void space (15) and outside environment (16) through the vents (5). The water infiltrates through the bio-mat (13) at the soil-water interface (14) where microbes entrain and digest suspended solids and consume dissolved organics and nutrients from the water. RAIL lengths can be connected in series to the desired length through joints (12) that connect both the pressure pipe (10) and headspace (15) between segments. Depending on the source, the influent water will commonly require pretreatment to prevent overloading in the form of settling, screening, filtration, biological treatment, chemical treatment, or other wastewater treatment technique.

An example of this is the installation of the RAIL beneath a backyard deck. The deck may be used to conceal the RAIL from view, provide additional utility of the space, as well as provide additional resilience to impacts and loads.

### II Detailed Aspects of the Present Invention

The Residential Aboveground Infiltration Line (RAIL) is generally a primarily at-grade leaching chamber with sidewalls that are inserted into the ground to a depth that eliminates the opportunity for water surfacing outside of the RAIL. Basic schematics of various configurations of the RAIL are shown in FIG. 1A, FIG. 1B, FIG. 2A, FIG. 2B, FIG. 3A, FIG. 3B, FIG. 4A, and FIG. 4B. The RAIL includes an arch or inverted trough structure with elongated sidewalls (7), roof (6), end caps (4), and an inlet structure (3).

The RAIL can include vents (5) to facilitate evaporation of wastewater, venting of gases, and/or temperature control of the void space (15). Vents (5) can be featured at the ends of each length of RAIL or they can be featured at intervals along its length. Air exchange between the void space (15) and the ambient environment (16) can be convective, forced by an air pump or fan, or forced by the inflow and outflow of water from the RAIL. Air filters may be included that are integral or follow the vent. Odorous compounds in the outflow may be adsorbed, digested or otherwise eliminated by the filtration substrate that may or may not include a carbon or biological filter. Examples of biofilter media include filter fabric, granular media, support media for plants, biochar, wood chips, or a combination thereof. A RAIL inlet vent (5) can be connected to the exhaust of a neighboring structure or process to control the internal temperature of the RAIL or provide a means of forced air flow.

The RAIL can contain width-ways or length-ways internal structural supports or bulkheads (8) to improve its load bearing characteristics. Any internal bulkheads (8) can facilitate the lengthways transport of gases through the length of the RAIL to any vent(s) (5) using air holes (9). Any internal bulkheads (8) will facilitate even distribution of wastewater through the length of the RAIL by allowing and disallowing overland and piped flow as appropriate. Bulkheads (8) can sit at the existing grade (18) or penetrate into the surface for an improved seal. Water holes (22) in the bulkheads (8) may be used to permit the passage of overland flow.

Treated effluent can be delivered by a distribution manifold (2) to an inlet structure (3) in the end cap (4), sidewall (7) or roof (6) of the RAIL. The RAIL can be of any cross-section that provides sufficient internal volume for water and air flow. Treated effluent can be distributed internally throughout the rail by overland flow, open channel flow, pressure pipe (10), or gravity distribution pipe (20).

The RAIL sidewalls (7), roof (6), end caps (4), and bulkheads (8) can be any single material or several connected materials that provide structural support while resisting corrosion, and preventing water from surfacing outside of the RAIL. The RAIL sidewalls (7) and roof (6) can be flat or otherwise feature texturing, ribs or corrugations to improve its structural properties, increase surface area, or limit the movement of neighboring soils. Further, the absorptivity, transmissivity, and heat transfer properties of the sidewalls (7) and roof (6) can be optimized for internal temperatures that support evaporation and/or bio-mat development, such as by admitting incident radiation (19) or insulating from adverse conditions. This can include but is not limited to acrylic, polyethylene, polycarbonate, tile, PVC, GFRP, CFRP, aluminum, steel, galvanized steel, stainless steel, wood, concrete, or molded plastic. The internal structural supports (8) can be made from any material that is both sufficiently corrosion resistant and sufficiently rigid and strong material to support the structure of the RAIL. This can include but is not limited to wood, acrylic, steel, concrete, molded plastic, CFRP, GFRP, aluminum, PVC, polycarbonate, polyethylene, and HDPE. The end caps (4) can be made from any material that is both sufficiently corrosion resistant and sufficiently rigid and strong material to support the structure of the RAIL. This can include but is not limited to wood, acrylic, steel, concrete, molded plastic, CFRP, GFRP, aluminum, PVC, polycarbonate, polyethylene, and HDPE.

A gravity distribution pipe (20) can consist of any sufficiently corrosion resistant material to handle regular exposure to wastewater. This can include but is not limited to copper, aluminum, fiberglass, PVC, ABS, CPVC, polyethylene, black steel, and acrylic. Perforations in the gravity distribution pipe (20) can typically range between ½″ to ¾″ and be typically spaced 5 inches apart. A pressure pipe (10) can be consist of any sufficiently strong and corrosion resistant material handle the internal water pressures. This can include but is not limited to copper, aluminum, fiberglass, PVC, ABS, CPVC, polyethylene, black steel, and acrylic. Perforations (11) in the pressure pipe (10) can typically range between 5/32″ to about ¼″ and be spaced 3-5 feet apart.

Operation of the RAIL requires an influent stream that may or may not be domestic wastewater. Water can be delivered to the RAIL from an equalization chamber (1) by gravity or it can be pumped by a pump (21). Treated effluent can be delivered as it is produced or in doses when it meets a threshold water level (17). The RAIL can be situated above or below the hydraulic grade line of the water source. When the RAIL is situated above the hydraulic grade line of the source, a pump is required to deliver the water to the RAIL.

The RAIL is designed to maximize distance between the soil/water interface (14) and the water table, increase evaporation rates, and provide a hospitable environment for a bio-mat (13) at the soil/water interface (14). Influent wastewater will be dispersed through the length of the RAIL where a fraction can be evaporated into the void space (15) above the water. Air can travel through the void space (15) either by convective or forced flow, entering through the inlet (3) or any vent(s) (5), and leaving via a vent(s) (3) further down the RAIL. The conductivity, absorptivity, or transmissivity of the sidewalls (7) and roof (6) can be adjusted to increase heat transfer from the external environment into the RAIL thereby increasing the rate of convective air flow and evaporation. The remaining liquid fraction will infiltrate down into the soil through the soil/water interface (14). A bio-mat (13) will preferentially develop at the soil/water interface (14) whereby suspended solids will be entrained and dissolved solids and nutrients will be digested.

Temperatures inside the RAIL can vary significantly depending on the environment and configuration. With the appropriate microbes in the bio-mat (13) the RAIL can be operated in thermophilic, mesophilic, or psychrophilic regimes. The bio mat can be comprised of autotrophic, phototropic, mixotrophic, chemotrophic, heterotrophic microorganisms, or a combination thereof. Within different regimes and at different influent concentrations the pathways of contaminant removal will vary.

The bio-mat (13) can be any appropriate pure or mixed culture, or a combination thereof. Preferably, the bio-mat can include heterotrophic, mixotrophic, and autotrophic microorganisms, or a combination thereof. Preferably, autotrophic microorganisms can include nitrifying or phototrophic microorganisms, or a combination thereof. Preferably heterotrophic microorganisms can include denitrifying or facultative microorganisms, or a combination thereof.

Preferably, nitrifying microorganisms can include one or more of the genera Nitrobacter, Nitrococcus, Nitrosococcus, Nitrosomonas, Nitrosovibrio, Nitrospina, Nitrospira, and SM1A02, or a combination thereof. Preferably, nitrifying microorganisms can include one or more of the species Nitrobacter alkalicus, Nitrobacter hamburgensis, Nitrobacter vulgaris, Nitrobacter winogradskyi, Nitrococcus mobilis, Nitrosococcus nitrous, Nitrosomonas aestuarii, Nitrosomonas cryotolerans, Nitrosomonas communis, Nitrosomonas europaca, Nitrosomonas eutropha, Nitrosomonas halophila, Nitrosomonas marina, Nitrosomonasmobilis, Nitrosomonas nitrosa, Nitrosomonas oligotropha, Nitrosomonas stercoris, Nitrosomonas urea, and Nitrospira inopinata, or a combination thereof. Preferably, denitrifying microorganisms can include one or more of the genera Achromobacter, Aeromonas, Alcaligenes, Bacillus, Dechloromonas, Flavobacterium, Haliangium, Micrococcus, Oligotropha, Paracoccus, Pseudomonas, Rhodoferax, Serratia, Sulfurtalea, Thauera, Thermomonas, Thiobacillus, and Zoogloca. Preferably, denitrifying microorganisms can include one or more of the species Micrococcus denitrificans, Pseudomonas aeruginosa, Thauera terpenica, Thiobacillus denitrificans, and Zoofloea ramigera, or a combination thereof.

Other heterotrophic and autotrophic genera of microorganisms can include one or more of the genera Acinetobacter, Alcaligenes, Alicycliphilus, Alsobacter, Akkermansia, Bauldia, Blastocatella, Brevibacterium, Brevifollis, Brevundimonas, Bryobacter, Caldininca, Calothrix, Candidatus Accumulibacter, Arenimonas, Caulobacter, Chryscobacterium, Cloacibacterium, Clostridium, Comomonas, Cytophage, Defluviimonas, Dinhuibacter, Dokdonella, Duganella, Ferruginibacter, Fimbriiglobus, Flavihumibacter, Flavobacterium, Haliangium, Hirschia, Holophaga, Hyphomicrobium, Janthinobacterium, Kaistia, Lactobacillus, Lactococcus, Leptospira, Luteibacter, Mesorhizobium, Methylorosula, Microbacterium, Mycobacterium, Niabella, Novosphingobium, Paracaedibacter, Paucibacter, Pedobacter, Polaromonas, Propionivibrio, Pseudomonas, Pseudolabrys, Ralstonia, Reyranella, Rhodanobacter, Rhizobacter, Rudaea, Simplicipira, Sphaerotilus, Sphingopyxis, Tabrizicola, Turneriella, Undibacterium, Woodsholea, and Yersinia, or a combination thereof.

Preferably, photosynthesizing microorganisms can include one or more of the genera Anabaena, Bacillariophyta, Botryococcus, Characium, Chlamydomonas, Chlorella, Desmodesmus, Dunaliella, Euglena, Haematococcus, Monoraphidium, Navicula, Nitzschia, Oocystis, Oscillatoria, Pichochlorum, Phormidium, Pseudocharaciopsis, Scenedesmus, Stigeoclonium, Synechocystis, Trichormus, and Tychonema. Preferably, photosynthesizing microorganisms can include one or more of the species Anabaena augstmalis, Botryococcus braunii, Chlorella minutissima, Chlorella sorokiniana, Chlorella vulgaris, Phormidium autumnale, Scenedesmus acutus, Scenedesmus quadricauda, Scenedesmus obliquus, Synechocystis aquatilis, and Trichormus variabilis, or a combination thereof.

Preferably, microbes with an affinity for or capacity to degrade contaminants of emerging concern can included in the present invention. Contaminants of emerging concern can include toxins, prescription and over-the-counter drugs, veterinary drugs, heavy metals, persistent organic compounds, toxins, and plastics. Specific examples include antibiotics, steroids, endocrine disruptors, diagnostic agents, cleaning products, stain-resistant coatings, nonstick coatings, water-resistant coatings, hormones, industrial additives, chemicals, fragrances, cosmetics, sun-screen products, x-ray contrast media, dietary supplements, detergents, antimicrobials, heavy metals, personal care products, cyanotoxins, nanoparticles, flame retardants, pesticides, per- and polyfluoroalkyl substances (PFAS) and microplastics. Treatment of emerging contaminants is typically done through adsorption, digestion, ultrafiltration, coagulation, activated carbon, and ozonation. The bio-mat can be used to filter or adsorb contaminants for sequestration or digestion. The microbes present in the bio-mat may include bacteria, algae, fungi and yeast. Preferably, bioremediating microorganisms can include one or more of the genera Achromobacter, Alcaligenes, Xanthobacter, Pseudomonas, Bacillus, Mycobacterium, Corynebacterium, Flavobacterium, Nitrosomonas.

One significant benefit of the RAIL system is that in leach field systems the top about 1 to about 2 inches of the soil at the soil/water interface can clog over the course of an about 20-year system lifetime and require refreshing. Location of the RAIL at grade eliminates the need for excavation to refresh the system. Preferably, the RAIL should be designed to facilitate case of refreshing the soil-water interface. This may or may not involve withdrawing the RAIL from the soil, or opening some part of the aboveground portion to reveal the internal contents.

Preferentially, the sidewalls (7) and roof (6) including the most bulky component of the RAIL, shall allow for nesting or stacking of multiple enclosures within one another for case of shipping and transport. Design lengths of the RAIL can be manufactured and transported as a single segment or multiple segments with or without any structural elements (8), vents (5), inlets (3), and end caps (4) previously integrated in manufacturing. If transported in multiple segments, the segments can be joined onsite to the desired length by one or multiple joints (12) which may include screws, silicon, rivets, adhesives, epoxies, nails, clamping, interlocking geometries, crimping, welding, or a combination thereof. The joint (12) can include a seal by a number of means including but not limited to a gasket, silicon, o-ring, press-fit, or a combination thereof.

The sidewalls (7) of the enclosure can be sufficiently strong to be hammered into unaltered soil or media or otherwise the underlying soil or media can be prepared to receive the sidewalls. The underlying media may or may not be prepared through trenching, sawing, cutting, splitting, or some combination thereof. The invention includes a tool for preparing the soil that cuts two parallel slots or narrow trenches at a width equivalent to the RAIL. This tool could be compared to a walk behind concrete saw, cable layer, or trencher but with two parallel cutting tools cable of cutting to a depth of between about 2 includes and about 24 inches. The slot can be (i) about the thickness of the sidewalls (7) or less to encourage a tight fit, and avoid hydraulic short circuiting along the support and subsequent surfacing of wastewater; (ii) greater than the thickness of the sidewall (7) and be filled or reinforced in a fashion that may or may not include cement, backfilling with media, shimming with trim, or a combination thereof. Installation of the RAIL in soils with higher shrink-swell characteristics during their dry-condition can improve the seal between the soil and the sidewall (7). The grade of the soil within the RAIL can be left at grade or trenching can be used to sink the RAIL lower into the soil so that it is less prominent above ground. The RAIL can be buried with soil and would remain different from conventional leaching chambers in that the sidewalls (7) are driven down beneath the soil/water interface (14) to permit the RAIL to be installed at shallower depths without the risk of water surfacing.

The sidewalls (7) of the RAIL can be made to be longer than necessary to prevent surfacing and perforations can be made in the sidewalls to increase the overall infiltrative surface and soil-water interface (14).

Water applied to the RAIL can be from a variety of sources that may or may not include storm water, greywater, blackwater, source separated urine, treated wastewater effluent, industrial wastewater, commercial wastewater, domestic wastewater, or a combination thereof.

The RAIL may or may not be used to infiltrate water into the ground, provide landscape irrigation, irrigate crops, or a combination thereof. The RAIL may or may not be structural design and spaced accordingly to act as garden edging, a deck or patio surface, walkway, driveway, or a combination thereof. Plants can be planted along the length of the RAIL in a fashion similar to that of Nutrient Film Technique aquaponics.

### III Imbedded Infiltration Device of the Present Invention

A first aspect of the present invention includes an embedded infiltration device, including: a) at least one leaching chamber; b) at least one means for distributing liquid through the length of the at least one leaching chamber; c) at least one inlet structure for the at least one leaching chamber; d) at least one top for the at least one leaching chamber existing at or above grade; e) at least one sidewall of the at least one leaching chamber inserted to a depth below grade and below at least one soil-liquid interface to facilitate infiltration while preventing the presence of liquid on the soil surface outside of the leaching chamber.

An alternative first aspect of the present invention includes an embedded infiltration device, including: a) at least one leaching chamber; b) at least one means for distributing liquid through the length of the at least one leaching chamber; c) at least one sidewall of the at least one leaching chamber inserted to a depth below grade and below at least one soil-liquid interface to facilitate infiltration while preventing the presence of liquid on the soil surface outside of the leaching chamber.

Another alternative first aspect of the present invention includes and embedded infiltration device, including: a) at least one leaching chamber; b) at least one means for distributing liquid through the length of the at least one leaching chamber; c) at least one inlet structure for the at least one leaching chamber; c) at least one sidewall of the at least one leaching chamber inserted to a depth below the soil-water interface.

### A. Leaching Chamber

Another aspect of the present invention includes wherein the at least one leaching changer includes at least one roof, at least one sidewall, at least one end-cap, or a combination thereof.

An further aspect of the present invention includes wherein the at least one roof, at least one sidewall, and at least one end-cap of said at least one leaching chamber are manufactured as a single component, more than one component and subsequently assembled and sealed, or a combination thereof.

An additional aspect of the present invention includes wherein the at least one leaching chamber is made at least in part from plastic, PVC, polyethylene, polystyrene, polypropylene, or a combination thereof.

An aspect of the present invention includes wherein the at least one leaching chamber is made at least in part by extrusion, molding, injection molding, or a combination thereof. Another aspect of the present invention includes wherein the at least one leaching chamber is made at least in part from sheet metal, iron, aluminum, or a combination thereof.

A further aspect of the present invention includes wherein the at least one leaching chamber is made at least in part from ceramics, concrete, brick, or a combination thereof.

An additional aspect of the present invention includes wherein the at least one leaching chamber is made to be sufficiently load bearing to act as a walkway or patio.

An aspect of the present invention includes wherein said at least one leaching chamber includes a nestable geometry to allow multiple leaching chambers to be stacked in transport.

Another aspect of the present invention includes wherein the at least one leaching chamber includes at least one roof component that can be opened or removed to allow maintenance access to the inside of said at least one leaching chamber.

### 1) Bulkhead

A further aspect of the present invention includes wherein the at least one leaching chamber includes at least one bulkhead to provide structure and/or encourage even distribution of wastewater.

An additional aspect of the present invention includes wherein the at least one bulkhead is integral to said at least one leaching chamber.

An aspect of the present invention includes wherein the at least one bulkhead is joined to the at least one leaching chamber.

Another aspect of the present invention includes wherein the at least one bulkhead is inserted to a depth below the soil-liquid interface similar to the sidewalls.

A further aspect of the present invention includes wherein the at least one bulkhead rests on the soil-liquid interface.

An additional aspect of the present invention includes wherein the at least one bulkhead includes at least one air hole to permit the flow of air through the length of the device.

An aspect of the present invention includes wherein the at least one bulkhead includes at least one liquid hole to permit the flow of liquid through the length of the device.

### 2) Vent Structure

Another aspect of the present invention includes wherein the at least one leaching chamber includes at least one vent structure to allow airflow in and out of said at least one leaching chamber.

A further aspect of the present invention includes wherein the at least one vent structure includes at least one air filter to reduce odors.

An additional aspect of the present invention includes wherein the at least one vent structure includes at least one fan or air pump to increase air flow.

An aspect of the present invention includes wherein the at least one leaching chamber passes heat from the external environment to the internal void space to encourage evaporation.

### B. Means for Distributing Liquid

Another aspect of the present invention includes wherein the at least one means for distributing liquid comprises at least one low pressure distribution pipe.

A further aspect of the present invention includes wherein the at least one means for distributing liquid includes an unobstructed overland flow path through the length of said at least one leaching chamber.

An additional aspect of the present invention includes wherein the at least one means for distributing liquid includes at least one perforated drain pipe.

### C. Inlet Structure

An aspect of the present invention includes wherein the at least one inlet structure is located at least in part on at least one end cap of the at least one leaching chamber.

Another aspect of the present invention includes wherein the at least one inlet structure is located at least in part on at least one roof of the at least one leaching chamber.

A further aspect of the present invention includes wherein the at least one inlet structure is located at least in part on at least one sidewall of the at least one leaching chamber.

An additional aspect of the present invention includes wherein the at least one inlet structure connects an external distribution manifold to at least one internal low pressure piping within the as least one leaching chamber.

An aspect of the present invention includes wherein the at least one inlet structure connects an external distribution manifold to at least one internal gravity distribution piping within the as least one leaching chamber.

Another aspect of the present invention includes wherein the at least one inlet structure connects an external distribution manifold to the internal void space of the at least one leaching chamber.

### D. Sidewall

A further aspect of the present invention includes wherein the at least one sidewall is made from impact resistant material to withstand weedwhackers.

An additional aspect of the present invention includes wherein the at least one sidewall is corrosion resistant to withstand the moist underground environment.

### E. Biomat

An aspect of the present invention further includes at least one biomat that develops directly on said soil-liquid interface.

Another aspect of the present invention further includes wherein at least one biomat that develops on a plastic fiber mat that rests on said soil-liquid interface.

A further aspect of the present invention further includes at least one biomat that includes a diverse consortia of microorganisms that includes autotrophic, heterotrophic, chemotrophic, mixotrophic genera, or a combination thereof, capable of removing contaminants from the distributed liquid.

### F. Additonal Aspects of the Invention

An additional aspect of the present invention includes wherein at least one carbon rich material can be loaded into the void space of the at least one leaching chamber to encourage biological nutrient removal of remaining soluble nutrients in the liquid stream and composting of remaining solids in the liquid stream.

An aspect of the present invention includes the embedded infiltration device with the at least one low pressure distribution pipe of the present invention; wherein at least one valve is included at the end of said at least one low pressure distribution pipe to facilitate flushing solids from the at least one low pressure pipe.

### II. Method of Installing a Device of the Present Invention

A second aspect of the present invention includes a method of installing an embedded infiltration device, including: a) providing the components of the device of the present invention; b) providing at least one ground location to accommodate said at least one leaching chamber; c) assembling the components of the device on or in the at least one ground location.

An aspect of the present invention includes wherein the vertical members of the at least one leaching chamber are pressed or hammered into said undisturbed at least one ground location.

Another aspect of the present invention includes wherein the at least one ground location is prepared by slicing or sawing to more easily accept the insertion of the vertical members of said at least one leaching chamber.

A further aspect of the present invention includes wherein the at least one ground location is prepared by trenching to more easily accept the insertion of the vertical members of the at least one leaching chamber followed by repacking the trench with soil, concrete, or other sufficiently sealing media.

### III. Method of Using a Device of the Present Invention

A third aspect of the present invention includes a method of using an embedded infiltration device, including: a) providing at least one embedded infiltration device of the present invention operably engaged with at least one ground location; b) providing at least one source of liquid for infiltration; c) flowing the liquid into the at least one embedded infiltration device; d) wherein the liquid is distributed into the at least one leaching chamber and onto soil.

An aspect of the present invention includes wherein the at least one source of liquid is at least one storm water.

Another aspect of the present invention includes wherein the at least one source of liquid is at least one treated wastewater.

A further aspect of the present invention includes wherein the at least one source of liquid is at least one untreated wastewater.

An additional aspect of the present invention includes wherein the leaching chamber can be fed at least in part by passively by gravity.

An aspect of the present invention includes wherein the leaching chamber can be fed at least in part by a low pressure distribution system.

Another aspect of the present invention includes wherein the leaching chamber can be fed at least in part by a siphon.

### EXAMPLES

### Example 1: Preferred Device

This example establishes a preferred device of the present invention.

The Residential Aboveground Infiltration Line (RAIL) was developed as a method to provide the benefit of gravel-less wastewater disposal while also eliminating the requirement for excavation.

The device can include but is not limited to:
(a) A leaching chamber structure that can be in the form of a half-pipe, inverted trough, inverted v, square, or any other arched shape with elongated sidewalls that can be pressed, hammered, or otherwise forced into the soil to a depth of between about 1″ and about 24″.
(b) A process that prepares the soil to receive the leaching chamber that can include (i) sawing two parallel slits in the earth to the depth of the depth of the sidewalls; (ii) like-wise trenching narrow lines in the soil; (iii) scarifying the surface of the soil; (iv) disturbing the entire area footprint of the rails.
(c) A means of distributing water through the length of the leaching chamber that can include (i) an about 3″ to about 4″ PVC pipe with about 0.5″ to about 0.75″ holes; (ii) an about 1″ to about 1.5″ low-pressure distribution pipe with about 5/32″ to about ¼″ holes; (iii) an open flow channel or; (iv) overland flow within the chamber.
(d) An internal bulkhead support structure that (i) maintains the form of the internal void space against external pressures from the environment above; (ii) facilitates air transport through the length of the conduit; (iii) facilitates even water distribution throughout the length of the conduit.
(e) An end cap component that seals the ends of the leaching chamber while providing a means of attaching an inlet.
(f) A means of connecting vertical vent stacks to the leaching chamber.
(g) A means of connecting adjacent leaching chambers.

### Example 2: Method of Making a Preferred Device

This example establishes a preferred method of making a preferred device of the present invention.

The present invention generally relates to a method for installing an at-grade leaching chamber into soil or other media and infiltrating wastewater, including but not limited to the following steps: a) Cutting rectangular slots in the soil to match the footprint of the leaching chamber(s) to be installed, b) pressing the sidewalls of a leaching chamber(s) into the slots along with any such sealers or fillers necessary to fill any excess void space in the slots, c) connecting an external water supply through the inlet of the leaching chamber(s) to the means of internal water distribution allowing water to be dispersed through the length of the leaching chamber(s), d) optionally connecting a vent at either end of the leaching chamber to facilitate the exchange of air with the outside environment.

### Example 3: Absorption Bed Areal Configuration

This example establishes a preferred method of orienting a system of at-grade leaching chambers into the soil or other media in an absorption bed configuration and infiltrating wastewater, including but not limited to the following steps:
(a) Cutting rectangular slots in the soil to match the footprint of the first leaching chamber to be installed.
(b) Cutting rectangular slots in the soil for each additional leaching chamber such that each leaching chamber shares a common slot with the last.
(c) Pressing the sidewalls of the leaching chamber(s) into the slots such that each additional leaching chamber directly abuts the last.
(d) Optionally installing a deck or other protective structure over the at-grade absorption bed to provide additional utility to the space or protect the system from impact, external loading, outdoor conditions, or other threats.

### Example 4: Linear Configuration

This example establishes a preferred method of orienting a system of at-grade leaching chambers into the soil or other media in a linear configuration and infiltrating wastewater, including but not limited to the following steps:
(a) Cutting rectangular slots in the soil to match the footprint of the first leaching chamber to be installed.
(b) Cutting slots for additional leaching chamber(s) such that they form a train that may resemble garden edging or paths.
(c) The locations of such trains may be chosen to be similar to traditional garden edging in order to provide subsurface irrigation of garden beds.

### Example 5: Low Pressure Distribution Device

This example establishes a preferred method of making a preferred low pressure distribution device of the present invention.

In one preferred aspect of the present invention, the RAIL can be installed with a low-pressure distribution line to facilitate even effluent distribution through the length of the rail in spite of an uneven natural side grade. This configuration comprises of:
(a) An about 12″ wide RAIL leaching chamber(s) with a sufficient length to cover the regulated infiltration area with sidewalls pressed about 3″ to about 6″ into the earth and a remaining void height of 2″ to about 4″ arranged in parallel and in series to a maximum single row length of about 100 ft.
(b) A dosing chamber that receives the treated effluent.
(c) A dosing pump and level sensor that intermittently discharges effluent to a distribution manifold.
(d) A distribution manifold that evenly delivers the pumped effluent to the inlet port of a single or multiple RAIL(s).
(e) An about 1″ to about 1.5″ low pressure line within each RAIL with an about 5/32″ to about ¼″ perforations spaced every about 3 ft to about 5 ft.
(f) Intermittent bulkheads every about 3 ft to about 5 ft that (i) provide structural support to the RAIL for any external loading; (ii) allow the passage of air through the length of each linear RAIL; (iii) prevent the overland flow of dosed water beyond each about 3 ft to about 5 ft segment.
(g) A valve at the end of each low pressure distribution line that may be opened prior to a pump event as a means of flushing solids from the pipes.

### Example 6: Gravity Fed Distribution Device

This example establishes a preferred method of making a preferred gravity fed distribution device of the present invention.

In another preferred embodiment, the RAIL can be installed with a gravity distribution system. This configuration comprises of:
(a) 12″ wide RAIL leaching chamber(s) with a sufficient length to cover the regulated infiltration area with sidewalls pressed about 3″ to about 6″ into the earth and a remaining void height of about 2″ to about 4″ arranged in parallel and in series to a maximum single row length of 100 ft.
(b) A distribution manifold that evenly delivers the pumped effluent to the inlet port of a single or multiple RAIL(s).
(c) Intermittent bulkheads every 3-5 ft that (i) provide structural support to the RAIL for any external loading; (ii) allow the passage of air through the length of each linear RAIL; (iii) allow the overland flow of water through the length of each RAIL.

All publications, including patent documents and scientific articles, referred to in this application and the bibliography and attachments are incorporated by reference in their entirety for all purposes to the same extent as if each individual publication were individually incorporated by reference.

All headings and titles are for the convenience of the reader and should not be used to limit the meaning of the text that follows the heading, unless so specified.

1. An embedded infiltration device, comprising:
a) at least one leaching chamber;
b) at least one means for distributing liquid through the length of said at least one leaching chamber;
c) at least one sidewall of said at least one leaching chamber inserted to a depth below grade and below at least one soil-liquid interface to facilitate infiltration while preventing the presence of liquid on the soil surface outside of the leaching chamber.

2. The embedded infiltration device of claim 1;
wherein said at least one leaching changer comprises at least one roof, at least one sidewall, at least one end-cap, or a combination thereof.

3. The embedded infiltration device of claim 2;
wherein said at least one roof, at least one sidewall, and at least one end-cap of said at least one leaching chamber are manufactured as a single component, more than one component and subsequently assembled and sealed, or a combination thereof.

4. (canceled)

5. (canceled)

6. (canceled)

7. (canceled)

8. (canceled)

9. The embedded infiltration device of claim 1;
wherein said at least one leaching chamber comprises a nestable geometry to allow multiple leaching chambers to be stacked in transport.

10. The embedded infiltration device of claim 1;
wherein said at least one leaching chamber comprises at least one roof component that can be opened or removed to allow maintenance access to the inside of said at least one leaching chamber.

11. The embedded infiltration device of claim 1;
wherein said at least one leaching chamber comprises at least one bulkhead to provide structure and/or encourage even distribution of wastewater.

12. (canceled)

13. (canceled)

14. (canceled)

15. (canceled)

16. The embedded infiltration device of claim 11;
wherein said at least one bulkhead comprises at least one air hole to permit the flow of air or liquid through the length of the device.

17. (canceled)

18. The embedded infiltration device of claim 1;
wherein said at least one leaching chamber comprises at least one vent structure to allow airflow in and out of said at least one leaching chamber.

19. (canceled)

20. (canceled)

21. The embedded infiltration device of claim 18;
wherein said at least one leaching chamber passes heat from the external environment to the internal void space to encourage evaporation.

22. The embedded infiltration device of claim 1;
wherein said at least one means for distributing liquid comprises at least one low pressure distribution pipe.

23. The embedded infiltration device of claim 1;
wherein said at least one means for distributing liquid comprises an unobstructed overland flow path through the length of said at least one leaching chamber.

24. The embedded infiltration device of claim 1;
wherein said at least one means for distributing liquid comprises at least one perforated drain pipe.

25. The embedded infiltration device of claim 1;
wherein at least one inlet structure is provided for said at least one leaching chamber connecting an external distribution manifold to said internal means for distributing liquid.

26. (canceled)

27. (canceled)

28. (canceled)

29. (canceled)

30. (canceled)

31. (canceled)

32. (canceled)

33. (canceled)

34. (canceled)

35. The embedded infiltration device of claim 1;
further comprising at least one biomat that develops on a plastic fiber mat that rests on said soil-liquid interface.

36. (canceled)

37. The embedded infiltration device of claim 1;
wherein at least one carbon rich material can be loaded into the void space of said at least one leaching chamber to encourage biological nutrient removal of remaining soluble nutrients in the liquid stream and composting of remaining solids in the liquid stream.

38. (canceled)

39. A method of installing an embedded infiltration device, comprising:
a) providing the components of the device of claim 1;
b) providing at least one ground location to accommodate said at least one leaching chamber;
c) assembling the components of said device on or in said at least one ground location.

40. The method of installing the embedded infiltration device of claim 39;
wherein the vertical members of said at least one leaching chamber are pressed or hammered into said undisturbed at least one ground location.

41. The method of installing the embedded infiltration device of claim 39;
wherein said at least one ground location is prepared by slicing or sawing to more easily accept the insertion of the vertical members of said at least one leaching chamber.

42. The method of installing the embedded infiltration device of claim 39;
wherein said at least one ground location is prepared by trenching to more easily accept the insertion of the vertical members of said at least one leaching chamber followed by repacking the trench with soil, concrete, or other sufficiently sealing media.

43. A method of using an embedded infiltration device, comprising:
a) providing at least one embedded infiltration device of claim 1 operably engaged with at least one ground location;
b) providing at least one source of liquid for infiltration;
c) flowing said liquid into said at least one embedded infiltration device;
d) wherein said liquid is distributed into said at least one leaching chamber and onto soil.

44. (canceled)

45. (canceled)

46. (canceled)

47. (canceled)

48. (canceled)

49. (canceled)
